(19) United States
(12) Patent Application Publication
(10) Pub. No.: US 2009/0079278 A1
(43) Pub. Date: Mar. 26, 2009

(54) SEGMENTED MOTOR COOLING JACKET

(76) Inventors: Dennis A. Kramer, Troy, MI (US); Adam Ritchie, Rochester Hills, MI (US); Vern Caron, Kalamazoo, MI (US); Mark C. Smith, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/858,372

(22) Filed: Sep. 20, 2007

(51) Int. Cl. H02K 9/00; B21C 23/00; B21D 53/02; B23P 15/26

(52) U.S. Cl. 310/54; 310/59; 29/890.035; 72/253.1

(57) ABSTRACT

A cooling jacket for an electric motor includes a plurality of jacket portions that are attached to each other to surround a motor stator. Each jacket portion is an extruded component that includes an outer peripheral wall and an inner peripheral wall spaced inwardly from the outer peripheral wall to form a cooling space between the inner and the outer peripheral walls. A plurality of connecting walls extends between the inner and the outer peripheral walls. The connecting walls cooperate with each other to define a plurality of discrete cooling passages within the cooling space of each jacket portion. First and second end caps are mounted to the plurality of jacket portions to enclose the plurality of discrete cooling passages such that a continuous cooling loop is provided through the plurality of jacket portions and the first and second end caps.

### TECHNICAL FIELD

The subject invention relates to a cooling jacket for an electric motor that is comprised of a plurality of extruded jacket portions with cooling passages, where the jacket portions are attached to each other to surround the electric motor.

### BACKGROUND OF THE INVENTION

Power density for an electric motor is related to the size of a rotor and stator. Typically, to increase power density, the size of the rotor and stator have to be correspondingly increased. However, the electric motors can be liquid cooled to increase power density without also having to increase the size of the rotor and stator. Liquid cooling permits higher motor currents for the same size rotors and stators that are not cooled.

Motor cooling jackets are used to provide the liquid cooling. One known motor cooling jacket comprises a single-piece cast component with cast-in-place cooling tubes. This type of cooling jacket is disadvantageous because cast tooling is costly and has long lead times. Also, cast tooling is inflexible in that each different motor configuration requires a unique casting. Further, the cast-in-place cooling tubes are limited in cooling capability.

Another type of cooling jacket comprises a single-piece extruded tubular component. This type of cooling jacket provides improved flow characteristics compared to cast jackets, but is also costly and not practical for motor sizes over nine inches in diameter.

Thus, there is a need for a cooling jacket for an electric motor that is less expensive to manufacture and provides better cooling characteristics, as well as overcoming other deficiencies in the prior art.

### SUMMARY OF THE INVENTION

A cooling jacket for an electric motor includes a plurality of jacket portions that are attached to each other to surround a motor stator. Each jacket portion includes a plurality of discrete cooling passages that are used to cool the electric motor. First and second end caps are mounted to the plurality of jacket portions to enclose the plurality of discrete cooling passages such that a continuous cooling loop is provided through the plurality of jacket portions and the first and second end caps.

In one example, each jacket portion is an extruded component that includes an outer peripheral wall and an inner peripheral wall spaced inwardly from the outer peripheral wall to form a cooling space between the inner and the outer peripheral walls. A plurality of connecting walls extends between the inner and the outer peripheral walls. The connecting walls cooperate with each other to define the plurality of discrete cooling passages within the cooling space of each jacket portion.

In one disclosed configuration, the plurality of discrete cooling passages includes first passages for fluid flow along a first direction and second passages for fluid flow along a second direction opposite of the first direction. The first and second end caps include connecting fluid passages to transfer fluid between the first and second passages. Each jacket portion includes at least one of the first passages and at least one of the second passages.

In one example, the electric motor defines a central axis with each jacket portion forming a segment that surrounds a portion of the central axis. The first and second passages include a main segment that extends in a direction that is generally parallel to the central axis.

One example method for forming a cooling jacket for an electric motor includes the steps of extruding a plurality of jacket portions that include a plurality of discrete cooling passages, attaching the plurality of jacket portions to each other to form a tubular cooling jacket that surrounds a motor stator, and attaching first and second end caps to the plurality of jacket portions to enclose the plurality of discrete cooling passages such that a continuous cooling loop is provided through the plurality of jacket portions and the first and the second end caps. The jacket portions can be extruded to an initial length, and can then be subsequently cut to different lengths to fit different motor configurations.

These and other features of the present invention can be best understood from the following specification and drawings, the following of which is a brief description.

### BRIEF DESCRIPTION OF THE DRAWINGS

FIG. 1 is a schematic representation of an electric motor with a cooling jacket.

FIG. 2 is a perspective view of one example of a cooling jacket for an electric motor.

FIG. 3 is a perspective view that shows the cooling jacket of FIG. 1 with ends caps.

FIG. 4 is a cross-sectional view of a motor with a cooling jacket.

FIG. 5 is a perspective view of another example of a cooling jacket for an electric motor.

FIG. 6 is a perspective view of the cooling jacket of FIG. 5 showing one end cap.

FIG. 7 is a perspective view of the cooling jacket of FIG. 5 showing the other end cap.

FIG. 8 shows internal fluid passages for the cooling jacket of FIG. 5.

### DETAILED DESCRIPTION OF THE PREFERRED EMBODIMENT

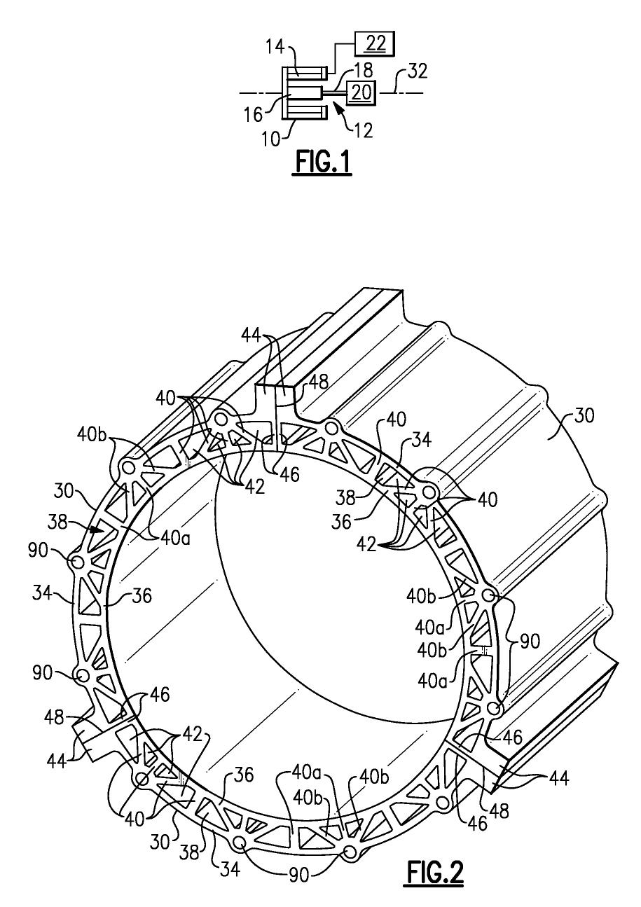

FIG. 1 shows a cooling jacket 10 for an electric motor 12 that has a stator 14 and rotor 16 coupled to an output shaft 18. The output shaft 18 is coupled to drive a vehicle drivetrain component 20, such as a vehicle wheel, for example. The cooling jacket 10 is in fluid communication with a cooling fluid supply 22. The cooling jacket 10 is comprised of a plurality of extruded jacket portions that are attached to each other to surround the electric motor 12.

One example of a cooling jacket 10 is shown in FIGS. 2-4. The cooling jacket 10 includes a plurality of jacket portions 30 that are extruded components. In one example, each jacket portion 30 is identical to the other jacket portions 30 such that a single extrusion can be used to form multiple jacket portions, which are then cut to a desired length and attached to each other to surround the electric motor 12.

The electric motor 12 defines a central axis 32 (FIG. 1) about which the output shaft 18 and rotor 16 rotate. Each jacket portion 30 includes an outer peripheral wall 34 and an inner peripheral wall 36 that is spaced inwardly from the outer peripheral wall 34 in a direction toward the central axis 32 to form a cooling space 38 between the inner 36 and outer 34 peripheral walls. Connecting walls 40 interconnect the inner 36 and outer 34 peripheral walls to define a plurality of discrete cooling passages 42 within the cooling space 38. In this example, each jacket portion 30 forms an arced segment that surrounds a portion of the central axis 32. When connected to each other, the jacket portions 30 completely surround the electric motor 12, i.e. the jacket portions 30 extend completely around the central axis 32. In the example shown, the jacket portions cooperate to form a tubular structure that is generally circular in shape; however, other tubular structures with other shape configurations could also be used, such as a square or rectangular shape, for example.

In the example shown in FIGS. 2-4, three (3) jacket portions 30 are used to form the cooling jacket 10. Each jacket portion 30 includes a flange 44 at each arc end 46. A flange 44 from one jacket portion 30 is abutted against a flange 44 from an adjacent jacket portion 30 to form a joint interface 48. The jacket portions 30 are secured to each other at the joint interfaces 48. In the example shown, the jacket portions 30 are welded to each other at the joint interface 48, however, other attachment methods could also be used, such as fasteners (bolts, screws, rivets, etc.), clamps, bands, straps, a keyed connection, a dovetail connection, or spring fasteners for example. In another example configuration, the flanges 44 could be eliminated such that edges of the arc ends 46 are welded directly to each other.

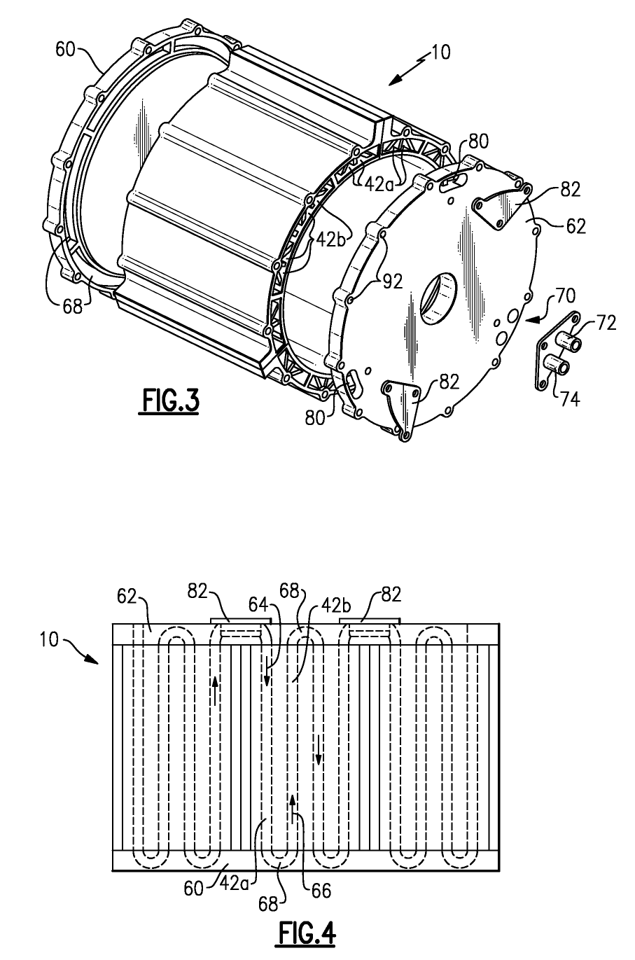

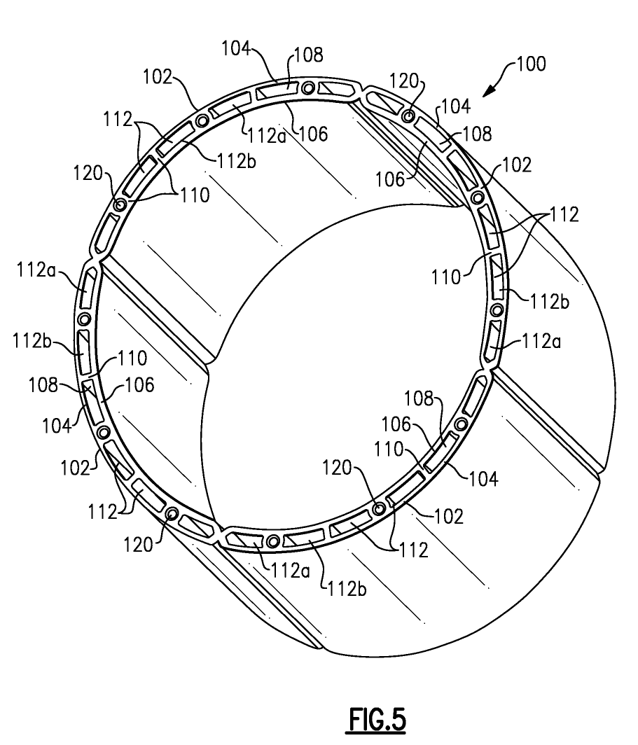

The plurality of discrete cooling passages 42 are shown in greater detail in FIGS. 3-4. In this example, the connecting walls 40 that form the cooling passages 42 include a set of radial walls 40a, which extend radially away from the central axis 32, from the inner peripheral wall 36 to the outer peripheral wall 34. The connecting walls 40 also include a set of angled walls 40b that extend obliquely relative to the radial walls 40a. In the example shown, the radial walls 40a are alternated with the angled walls 40b such that each radial wall 40a is positioned between a pair of angled walls 40b, and each angled wall 40b is positioned between a pair of radial walls 40a.

First 60 and second 62 end caps are secured to the jacket portions 30 to enclose the plurality of discrete cooling passages such that a continuous cooling loop is provided through the plurality of jacket portions 30 and the first 60 and second 62 end caps to cool an outer periphery of the electric motor 12. In each jacket portion 30, at least some of the cooling passages 42a are for fluid flow in a first direction, i.e. toward one end cap 60 along the central axis 32 as indicated by arrow 64, and at least some of the cooling passages 42b are for fluid flow in a second direction as indicated by arrow 66 (opposite of the first direction), i.e. toward the opposite end cap 62. The end caps 60, 62 include connecting fluid passages 68 formed within the respective end cap 60, 62 such that fluid can flow back and forth between the cooling passages 42a and 42b.

One of the end caps 60, 62 includes a connection interface 70 for fluid communication with the cooling fluid supply 22. The connection interface 70 includes a fluid inlet 72 that is connected to the cooling fluid supply 22 and a fluid outlet 74 that transfers heated fluid out of the electric motor 12 to be cooled for recirculation back through the cooling fluid supply 22.

One of the end caps 60, 62 also includes fluid connection interfaces 80 that allow fluid to be transferred between adjacent jacket portions 30. The fluid connection interfaces 80 are aligned generally with the joint interfaces 48 of the jacket portions 30. Cover plates 82 are used to cover and seal the fluid connection interfaces 80. In the example shown in FIG. 3, there are three (3) joint interfaces 48. Two of the joint interfaces are aligned with fluid connection interfaces 80, and the third joint interface has a fluid communication transfer via the fluid inlet 72 and fluid outlet 74. Gaskets (not shown) can be used at the cover plates and/or between the end caps and jacket portions as needed to provide a tightly sealed environment.

Each jacket portion 30 also includes a plurality of holes 90 that receive fasteners (not shown) to secure the end caps 60, 62 to the jacket portions 30. The end caps 60, 62 also include holes 92 that are aligned with the holes 90 in the jacket portions 30.

The jacket portions 30 are secured together to form the tubular cooling jacket 10 that surrounds the stator 14 and is in thermal contact with the stator 14. The jacket portions 30 are identical segments that are extruded from an extrusion die. The segments are attached to the stator 14 by a “hot dropping” process to form a complete band in tension. Hot dropping refers to a process where the jacket portions 30 are secured together with their inner peripheral surfaces subsequently being machined to provide a final inner diameter size. Then the formed cooling jacket is heated and pressed to a cooler stator until both the jacket 10 and the stator 14 are at a common temperature. This provides the band of tension.

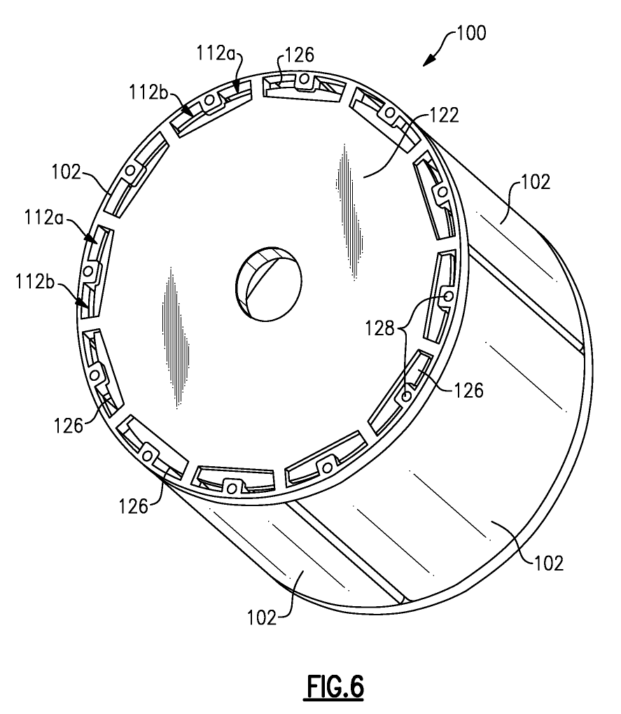

Another example of a cooling jacket 100 is shown in FIGS. 5-8. This configuration is similar to that of FIGS. 2-4 but uses four jacket portions 102 instead of three. The jacket portions 102 are secured together as described above to completely surround the central axis 32. Each jacket portion 102 includes an outer peripheral wall 104 and an inner peripheral wall 106 that is spaced inwardly from the outer peripheral wall 104 in a direction toward the central axis 32 to form a cooling space 108 between the inner 106 and outer 104 peripheral walls. Connecting walls 110 interconnect the inner 106 and outer 104 peripheral walls to define a plurality of discrete cooling passages 112 within the cooling space 108. Thus, each jacket portion 102 forms an arced segment that surrounds a portion of the central axis 32.

The connecting walls 110 in this configuration are generally radial walls that extend in a radial direction away from the central axis 32 from the inner peripheral wall 106 to the outer peripheral wall 104. The connecting walls 110 are spaced apart from each other about the central axis 32 to form the cooling passages 112. Some of the cooling passages (FIGS. 5 and 8) 112a flow in one direction along the central axis 32 and some of the cooling passages 112b flow in an opposite direction along the central axis 32. In this configuration, the cooling passages 112a and 112b alternate with each other.

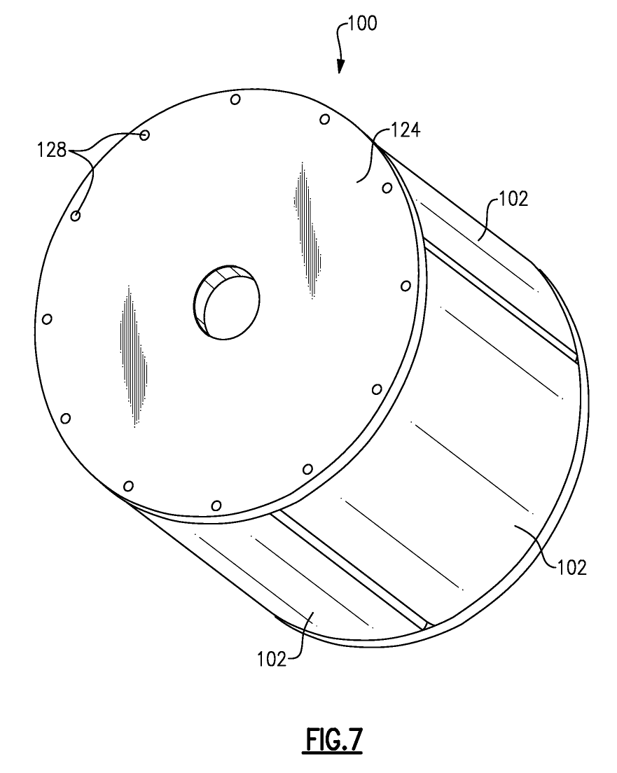

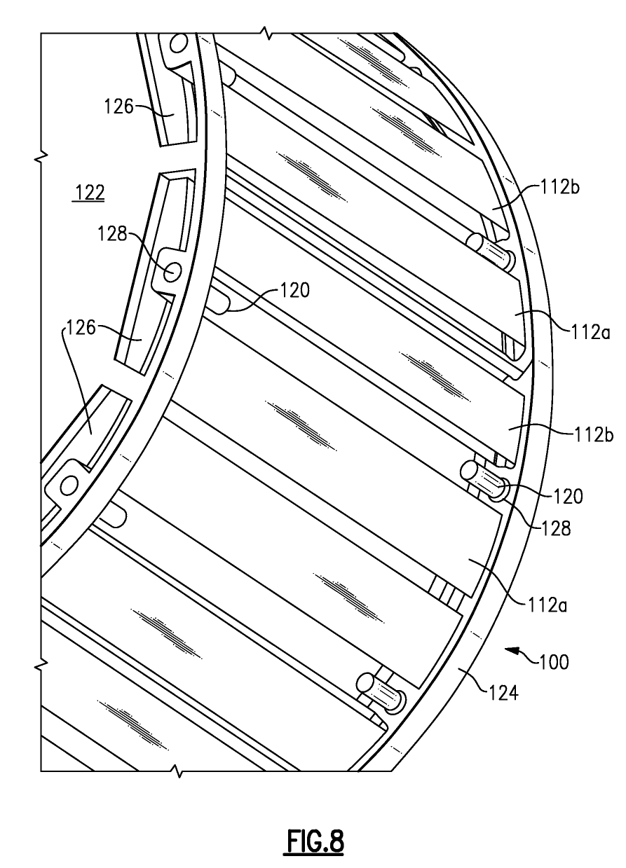

Between each pair of passages 112a and 112b is a hole 120 that is to receive a fastener (not shown) that is used to secure first 122 (FIG. 6) and second 124 (FIG. 7) end caps to the jacket portions 102. The end caps 122, 124 include fluid connection interfaces 126 formed within the caps that allow fluid to transfer between the alternating flow cooling passages 112a and 112b. One of the fluid connection interfaces 126 is fluidly connected to an inlet and outlet associated with the cooling fluid supply 22 as described above.

Further, the end caps 122, 124 include holes 128 that are aligned with holes 120 in the jacket portions 102. The fasteners extend into the holes 120, 128 to secure and clamp the jacket portions 102 and end caps 122, 124 together in compression.

A method for forming the cooling jackets described above includes the following steps. A plurality of jacket portions 30, 102 are extruded with each jacket portion 30, 102 including an outer peripheral wall 34, 104, an inner peripheral wall 36, 106 spaced inwardly from the outer peripheral wall 34, 104 to form a cooling space 38, 108 between the inner and the outer peripheral walls, and a plurality of connecting walls 40, 110 extending between the inner and the outer peripheral walls to form a plurality of discrete cooling passages 42, 112 within the cooling space. The jacket portions 30, 102 are attached to each other to form a tubular cooling jacket 10, 100 that surrounds a motor stator 14. Then, first 60, 122 and second 62, 124 end caps are attached to the plurality of jacket portions to enclose the plurality of discrete cooling passages such that a continuous cooling loop is provided through the plurality of jacket portions and the first and the second end caps.

In an alternate configuration, the cooling jackets 10, 100 could also provide for unidirectional flow. In this configuration, cooling fluid would flow through the cooling passages from one end cap to the other end cap. Cooling fluid would be supplied to one end cap at an inlet, cooling fluid would flow in one direction through the cooling passages, and would then exit the other end cap via an outlet. The heated cooling fluid would then be cooled back down and routed back to the inlet via the cooling fluid supply to provide a continuous cooling loop.

During the extrusion process, the jacket portion is extruded to form an elongated jacket portion. The jacket portions are identical to each other such that the elongated jacket portion is cut into sections of identical length to each other, with the cut sections being attached to each other to surround the stator. This is a very cost effective method for forming a cooling jacket. Also, the jacket portions can be cut to different lengths from the elongated extrusion to accommodate different motor configurations.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A cooling jacket for an electric motor comprising:
a plurality of jacket portions with each jacket portion comprising an extruded component that has an outer peripheral wall and an inner peripheral wall spaced inwardly from said outer peripheral wall to form a cooling space between said inner and said outer peripheral walls, and wherein said plurality of jacket portions are attached to each other to surround a motor stator;
a plurality of connecting walls extending between said inner and said outer peripheral walls, said plurality of connecting walls cooperating with each other to define a plurality of discrete cooling passages within said cooling space of each jacket portion; and
first and second end caps mounted to said plurality of jacket portions to enclose said plurality of discrete cooling passages such that a continuous cooling loop is provided through said plurality of jacket portions and said first and said second end caps.

2. The cooling jacket according to claim 1 wherein said plurality of jacket portions are attached to each other to form a tubular cooling jacket that is to completely surround an outer circumference of the motor stator.

3. The cooling jacket according to claim 1 wherein extruded surfaces define each of the discrete cooling passages.

4. The cooling jacket according to claim 1 wherein each jacket portion includes a plurality of mounting holes to receive fasteners to secure said first and said second end caps to said plurality of jacket portions.

5. The cooling jacket according to claim 1 wherein the cooling jacket defines a central axis to extend along a length of an electric motor with each of said jacket portions forming a segment that surrounds a portion of said central axis.

6. The cooling jacket according to claim 1 wherein said plurality of discrete cooling passages includes at least a first passage for fluid flow in a first direction and a second passage for fluid flow in a second direction opposite of the first direction, and wherein each jacket portion includes at least one first passage and at least one second passage.

7. The cooling jacket according to claim 6 wherein said first and said second end caps include connecting passages to transfer fluid between said first and said second passages.

8. The cooling jacket according to claim 6 wherein said plurality of jacket portions are connected to each other at joint interfaces, and wherein said first and said second end caps include fluid connection interfaces located at said joint interfaces to transfer fluid from one jacket portion to an adjoining jacket portion.

9. The cooling jacket according to claim 1 wherein at least one of said first and said second end caps includes an inlet for connection with a cooling fluid source to supply cooling fluid to said plurality of discrete cooling passages and an outlet to transfer heated fluid away from the motor stator.

10. The cooling jacket according to claim 1 wherein said plurality of discrete cooling passages defines a unidirectional flow path from one of said first and second end caps to the other of said first and second end caps.

11. A method for forming a cooling jacket for an electric motor comprising the steps of:
(a) extruding a plurality of jacket portions with each jacket portion including an outer peripheral wall, an inner peripheral wall spaced inwardly from the outer peripheral wall to form a cooling space between the inner and the outer peripheral walls, and a plurality of connecting walls extending between the inner and the outer peripheral walls to form a plurality of discrete cooling passages within the cooling space;
(b) attaching the plurality of jacket portions to each other to form a tubular cooling jacket that is to surround a motor stator; and
(c) attaching first and second end caps to the plurality of jacket portions to enclose the plurality of discrete cooling passages such that a continuous cooling loop is provided through the plurality of jacket portions and the first and the second end caps.

12. The method according to claim 11 including extruding the plurality of jacket portions to have an initial length and cutting the plurality of jacket portions to a first length that is shorter than the initial length to form jacket portions for a first motor configuration.

13. The method according to claim 12 including cutting the plurality of jacket portions to a second length that is shorter than the initial length to form jacket portions for a second motor configuration, the second length being different from the first length.

14. The method according to claim 11 including forming the plurality of discrete cooling passages to extend in a direction generally parallel to a central axis defined by the electric motor.

15. The method according to claim 14 including forming connecting fluid passages in the first and the second end caps to transfer cooling fluid between adjacent jacket portions.

16. The method according to claim 15 wherein the plurality of discrete cooling passages includes at least a first passage for fluid flow in a first direction along the central axis and a second passage for fluid flow in a second direction opposite of the first direction, and including forming each jacket portion with at least one first passage and at least one second passage.

17. The method according to claim 11 including forming the plurality of jacket portions to be identical to each other.
